(19) United States
(12) Patent Application Publication
(10) Pub. No.: US 2024/0180069 A1
(43) Pub. Date: Jun. 6, 2024

(54) ROTARY CUTTER WITH SENSORIZED GEAR BOXES

(71) Applicant: Oregon Tool, Inc., Portland, OR (US)

(72) Inventors: Robert A. Dewey, II, Amboy, IL (US); Jordan Kusiek, Beaverton, OR (US)

(73) Assignee: Oregon Tool, Inc., Portland, OR (US)

(21) Appl. No.: 18/526,836

(22) Filed: Dec. 1, 2023

Related U.S. Application Data
(60) Provisional application No. 63/429,695, filed on Dec. 2, 2022.

(51) Int. Cl. A01D 34/00; F16H 57/02

(52) U.S. Cl. CPC A01D 34/006; F16H 57/02; A01D 34/66

(57) ABSTRACT

A rotary cutter includes a gear box, a sensor coupled to the gear box and configured to measure a condition of the gear box, a light source coupled to the gear box, and processing circuitry communicatively coupled to the sensor and the light source. The processing circuitry is configured to cause the light source to illuminate at the gear box in response to determining that a measurement from the sensor satisfies a criterion.

### CROSS-REFERENCE TO RELATED APPLICATIONS

This application claims the benefit of and priority to U.S. Provisional Patent Application No. 63/429,695, filed Dec. 2, 2022, the entire disclosure of which is incorporated by reference herein in its entirety.

### BACKGROUND

The present disclosure relates generally to tractor attachments or implements, in particular to rotary cutters. Rotary cutters are pulled behind tractors and include rotating blades which cut, chop, shred, etc. plant matter such as grass, crops, brush, etc. In use, a rotary cutter is often exposed to harsh environments and forces and can sustain wear, damage, etc. which degrades performance of the rotary cutter and/or which would benefit from maintenance of the rotary cutter.

### SUMMARY

One implementation of the present disclosure is a rotary cutter. The rotary cutter includes a gear box, a sensor positioned adjacent the gear box and configured to measure a condition of the gear box, an indicator or light source positioned on the gear box, processing circuitry communicatively coupled to the sensor and the light source, wherein the processing circuitry is configured to cause the indicator light to illuminate at the gear box in response to determining that a measurement from the sensor satisfies a criterion.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a rotary cutter, according to some embodiments.

FIG. 2 is a block diagram of a monitoring system for a rotary cutter, according to some embodiments.

FIG. 3 is storyboard-style illustration of operation of a gear box consistent with FIGS. 1 and 2, according to some embodiments.

FIG. 4 is a first view of a cover of a gear box, according to some embodiments.

FIG. 5 is a second view of a cover of a gear box, according to some embodiments.

FIG. 6 is a view of a bottom panel of a cover of a gear box, according to some embodiments.

FIG. 7 is a view of a top panel of a cover of a gear box, according to some embodiments.

FIG. 8 is a view of a sensor plug, according to some embodiments.

FIG. 9 is a view of a plug, according to some embodiments.

### DETAILED DESCRIPTION

Referring generally to the figures, teachings relating to monitoring conditions at one or more gear boxes of a rotary cutter are shown, according to some embodiments. The teachings herein also relate to providing visual feedback to a user in response to undesirable conditions occurring at the one or more gear boxes.

In use, a rotary cutter will likely be exposed to large forces, harsh environments, vibrations, and/or other physical conditions which can cause wear, damage or degradation over time to components of the rotary cutter. Because a rotary cutter is conventionally pulled behind a tractor in use, degradation, damage, failure, etc. of components of the rotary cutter is typically difficult for an operator (driver) of the tractor to notice because the implement is typically towed behind the tractor and the driver is typically looking in the opposite direction of the towed implement while in use. An operators can thus unknowingly continue operating the rotary cutter with a degraded or failed component. Continued operation of a rotary cutter with a degraded or failed component can cause damage to additional components and/or increase the difficulty or time for repairs. Accordingly, features which monitor rotary cutter health and identify undesirable conditions to the operator can advantageously reduce damage, reduce equipment downtime, reduce repair costs, etc.

One example component which can degrade in operation of a rotary cutter is a seal (gasket, etc.) of a gear box of the rotary cutter. The gear box typically holds oil to enable low friction articulation of one or more gears within the gear box, which operates to drive one or more blades of the rotary cutter. Degradation or failure of a seal can result in the lubricating oil to leak out of the gear box, and continued operation of the rotary cutter without sufficient lubricating oil in the gear box can result in damage to gears and drive mechanism within the gear box. Replacement of the seal is relatively quick and low-cost relative to repair or replacement of failed gears in the gear box, but a tractor operator conventionally has no way while operating the tractor and rotary cutter, to tell that a seal is degraded/failed and/or that oil is leaking from the gear box, which can result in the risk of damage to gears in the gear box and lost productivity of the equipment. Advantageously, embodiments herein provide a sensor at a gear box to measure a condition indicative of oil level in the gear box (e.g., temperature which rises in low-oil conditions) and provide feedback to the operator when an undesired condition occurs (e.g., measured temperature is greater than a threshold value) can enable the operator to stop operation of the rotary cutter before additional gear box components are damaged, replace the seal and lost oil, and quickly restart use of the rotary cutter.

Exposure of rotary cutters to harsh conditions, forces, etc. in use also provides challenges for electronic components thereon. As explained in further detail below, the teachings of the present application provide for deployment of sensors, indicators such as light sources, processing circuitry, cabling, etc. on a rotary cutter in a mechanically-robust manner adapted to withstand the harsh operations of such rotary cutter.

While the primary examples herein relate to rotary cutters, the teachings can be adapted for other tractor attachments (e.g., tillers, seeders, snow blowers, shredders, etc.) and/or other types of landscaping or agricultural equipment or devices (e.g., finish mowers, zero-turn mowers, lawn mowers). The rotary cutter, or other attachment, implement, equipment, etc. may be primarily powered by a combustion engine (e.g., of a conventional tractor) or by electrical power, for example using electric motors locally at the rotary cutter, locally at each gear box, etc. or one or more electric motors of an electric tractor operating with the rotary cutter or other equipment.

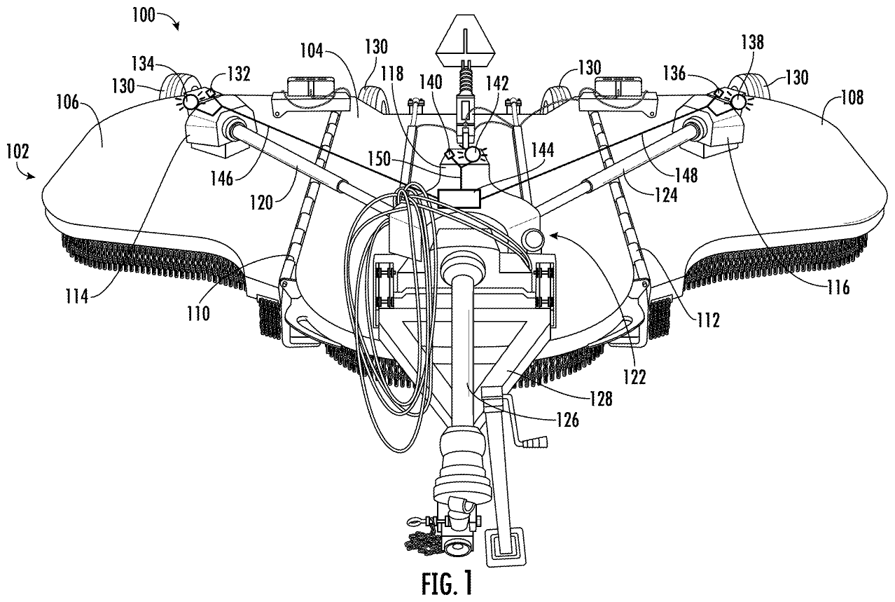

Referring now to FIG. 1, a rotary cutter 100 including a condition monitoring system is shown, according to some embodiments. The rotary cutter 100 includes a deck 102 including a middle portion 104, a first wing 106 coupled to the middle portion 104, and a second wing 108 coupled to the middle portion 104 such that middle portion 104 is positioned intermediate the first wing 106 and the second wing 108. In the example shown, the first wing 106 is coupled to the middle portion 104 via joints 110 that enable the first wing 106 to rotate relative to the middle portion 104 about the joints 110 so that the first wing 106 can be brought from an orientation aligned with the middle portion 104 (as shown in FIG. 1) to a position with an acute or right angle between the first wing 106 and the middle portion 104 of the deck 102 and anywhere in-between. The second wing 108 is shown as being coupled to the middle portion 104 via joints 112 that enable second wing 108 to rotate relative to the middle portion 104 about the joints 112 so that the second wing 108 can be brought from an orientation aligned with the middle portion 104 (as shown in FIG. 1) to a position with an acute or right angle between the second wing 108 and the middle portion 104 of the deck 102 and anywhere in-between.

The rotary cutter 100 also includes a first gear box 114 coupled to and positioned on the first wing 106, a second gear box 116 coupled to and positioned on the second wing 108, and third gear box 118 coupled to and positioned on the middle portion 104 of the deck 102. The first gear box 114 is coupled to and configured to affect rotation of a first blade positioned on an underside of the first wing 106 (i.e., on an opposite side of the first wing 106 as the first gear box 114). The second gear box 116 is coupled to and configured to affect rotation of a second blade positioned on an underside of the second wing 108 (i.e., on an opposite side of the second wing 108 as the second gear box 116). The third gear box 118 is coupled to and configured to affect rotation of a third blade positioned on an underside of the middle portion 104 of the deck 102 (i.e., on an opposite side of the middle portion 104 as the third gear box 118).

The rotary cutter 100 also includes a first shaft 120 coupled to and extending from the first gear box 114 to a hub 122 of the rotary cutter 100 coupled to and positioned on the middle portion 104 of the deck 102. The rotary cutter 100 also includes a second shaft 124 coupled to and extending from the second gear box 116 to the hub 122. The first shaft 120 is mechanically connected to the first gear box 114 such that rotation of the first shaft 120 causes rotation of gears in the first gear box 114 (and rotation of the first blade coupled to the first gear box 114). The second shaft 124 is mechanically connected to the second gear box 116 such that rotation of the second shaft 124 causes rotation of gears in the second gear box 116 (and rotation of the second blade coupled to the second gear box 116). The hub 122 is also coupled to the third gear box 118, for example by a third shaft extending between the hub 122 and the third gear box 118 and rotatable to rotate gears of the third gear box 118 (and a third blade coupled to the third gear box 118).

The rotary cutter 100 further comprises a drive shaft 126 coupled to and extending from the hub 122, and extending away from the deck 102. The drive shaft 126 is configured to be coupled to a rotary output of a tractor (or other equipment with a mechanical rotary output), such that the tractor (or other equipment) can operate to rotate the drive shaft 126 about its longitudinal axis. The hub 122 is configured to receive such rotary motion/energy/etc. from the drive shaft 126 and translate such rotation to rotation of the first shaft 120 (which in turn provides rotation to the first gear box 114), the second shaft 124 (which in turn provides rotation to the second gear box 116), and to the third gear box 118 (e.g., directly or indirectly in various embodiments).

The rotary cutter 100 is further shown as including a hitch 128 configured to couple the rotary cutter 100 to a tractor (or other equipment or vehicle) such that the tractor can move (e.g., pull) the rotary cutter 100. The rotary cutter 100 is shown as including wheels 130 to facilitate such movement of the rotary cutter 100.

In operation, the rotary cutter 100 can be pulled behind a tractor, which provides translation of the rotary cutter 100 via the hitch 128 and rotational of the drive shaft 126. Rotation of the drive shaft 126 causes rotation of gears of the first gear box 114, the second gear box 116, and the third gear box 118. Such gears can operate to increase a rotational frequency, for example to turn blades at a substantially higher number of rotations per minute as compared to a rotational frequency of the drive shaft 126. To facilitate high-speed operations, the first gear box 114, the second gear box 116, and the third gear box 118 typically contain oil which provides lubrication to gears therein. While the rotary cutter 100 includes three gear boxes, blades, etc., rotary cutters having a single gear box, two gear boxes, four gear boxes, etc. are also within the scope of the present disclosure and the teaching herein can be adapted to such implementations.

As shown in FIG. 1, the rotary cutter 100 further includes a monitoring system (e.g., condition monitoring system, rotary cutter health monitoring system, gear box monitoring system, sensor system, alarm system, alert system, etc.). In particular, the rotary cutter 100 is shown as including, a first sensor 132 and a first indicator, specifically a first light source 134 coupled to and positioned at (e.g., mounted on) the first gear box 114, a second sensor 136 and a second indicator, specifically a second light source 138 coupled to and positioned at (e.g., mounted on) the second gear box 116, and a third sensor 140 and a third indicator, specifically a third light source 142 coupled to and positioned at the third gear box 118. The rotary cutter 100 is further shown as including a controller 144 coupled to the first sensor 132 and the first light source 134 via a first cable 146, to the second sensor 136 and the second light source 138 via a second cable 148, and to the third sensor 140 and the third light source 142 via a third cable 150. The controller 144 is shown as being coupled to and positioned at (e.g., mounted on) the hub 122.

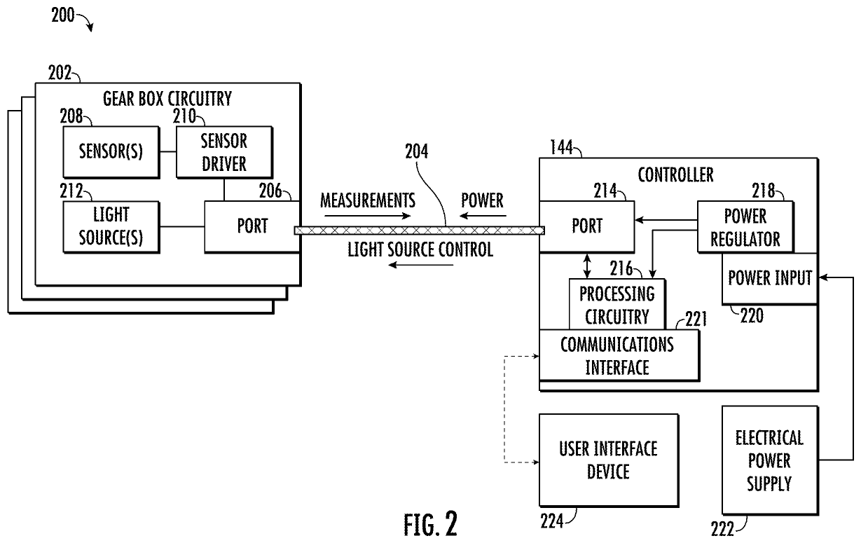

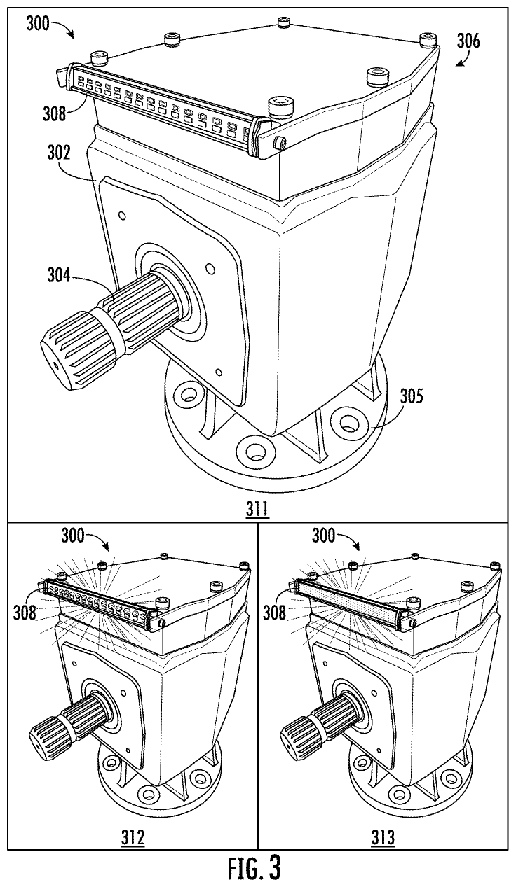

As described in further detail below with reference at least to FIGS. 2-3, the controller 144 of the rotary cutter 100 is configured to monitor one or more conditions (e.g., temperature, vibration, acceleration, orientation, angular motion, distance, speed, noise, oil level, pressure, force) at the gear boxes 114/116/118 using the sensors 132/136/140 and affect an operation of the light sources 134/138/142 in response to the one or more monitored conditions satisfying one or more criteria (e.g., cause one or more of the sources 134/138/142 to illuminate, blink, shine, flash, etc.). The rotary cutter 100 can thus be characterized as including a monitoring system that includes at least the first sensor 132, the first light source 134, the second sensor 136, the second light source 138, the third sensor 140, the third light source 142, the controller 144, the first cable 146, the second cable 148, and the third cable 150. In some embodiments, the first cable 146, the second cable 148, and the third cable 150 are eliminated and wireless communications are used.

In some embodiments, the rotary cutter includes one or more sensors located elsewhere than at a gear box (e.g., spaced apart from the gear boxes). For example, a sensor may be coupled to and positioned on the deck 102, for example on a top side of the deck 102 or an underside of the deck 102. In some such embodiments, the sensor may be a vibration sensor (e.g., accelerometer) configured to measure vibration of the deck 102. Various sensor locations and types of sensors are within the scope of the present disclosure. The various teachings herein relating to sensors, monitoring systems, etc. can be adapted for use with such sensors located away from gear boxes, as additions or alternatives to one or more sensors positioned at gear boxes.

Referring now to FIG. 2, a block diagram of a monitoring system 200 for a rotary cutter (e.g., as included with the rotary cutter 100) is shown, according to some embodiments. The monitoring system 200 is shown as including the controller 144 communicable with one or more units of gear box circuitry 202 via cable a 204 (e.g., first cable 146, second cable 148, or third cable 150). In some embodiments, the monitoring system 200 includes a first unit of the gear box circuitry 202 positioned at first gear box 114, a second unit of the gear box circuitry 202 positioned at the second gear box 116, and a third unit of the gear box circuitry 202 positioned at the third gear box 118. The units of gear box circuitry 202 may be substantially the same, such that the following passages describing the gear box circuitry 202 can be extended for each gear box of a rotary cutter.

The gear box circuitry 202 is shown as including a port 206, one or more sensors 208 communicable with the port 206 via a sensor driver 210, and one or more light sources 212 communicable with the port 260. The port 206, the sensor driver 210, the one or more sensors 208, and the one or more light sources 212 may be connected together by wired connections. The port 206 is configured to receive the cable 204 such that signals, electricity, etc. can be received by the port 206 from the cable 204 and such that signals can be provided from the port 206 to the cable 204.

The one or more sensors 208 are configured to measure one or more conditions of a gear box of a rotary cutter. For example, the one or more sensors 208 can include the first sensor 132, the second sensor 136, or the third sensor 140 of FIG. 1 described above, for example optionally further including one or more additional sensors. For example, the one or more sensors 208 can be or include a temperature sensor (e.g., thermocouple), an oil level sensor, an vibration sensor (e.g., accelerometer), a pressure sensor, a strain gauge, a distance sensor (e.g., LIDAR, ultrasonic), a speed sensor, a Global Positional Sensor (GPS), a gyroscope, an inertial measurement sensor (IMU), or other type of sensor in various embodiments.

The sensor driver 210 is configured to facilitate operations of the one or more sensors 208. For example, the sensor driver 210 may be configured to transform signals from the sensor(s) 208 (e.g., analog signals) into meaningful data (e.g., digital values, decoded signals, data in a readable data protocol). Such transformed (processed, preprocessed, etc.) data can then be provided from the sensor driver 210 to the port 206, and from the port 206 to the controller 144 via the cable 204. The sensor driver 210 may also be configured to manage a sample rate of the sensor(s) 208, a power supply to the sensor(s) 208, a calibration of the sensor(s) 208, or other operation facilitating operation of the sensor(s) 208.

The one or more light source(s) 212 are configured to selectively illuminate to emit light, for example light in one or more colors (e.g., white, red, green, blue). In some embodiments, the one or more light source(s) 212 include an array of light emitting diodes (LEDs). In some embodiments, the one or more light source(s) 212 include an incandescent lightbulb or fluorescent tube (e.g., neon light tube).

In some embodiments, the one or more light source(s) 202 can include circuitry, digital switches, etc. configured to operate responsive to requests received via the port 206 to cause the light source(s) 202 to turn on, turn off, flash, blink, change light colors, etc. As shown, the gear box circuitry 202 is configured such that the one or more light source(s) 202 are powered by electricity received at the gear box circuitry 202 via the cable 204 and the port 206. In some embodiments, the one or more light source(s) 202 are turned on/off, blinked, flashed, etc. by controlling the electricity supplied to the cable 204 (e.g., switching such electricity on and off), for example by operation of the controller 144.

FIG. 2 shows the controller 144 as including a port 214 receiving the cable 204, processing circuitry 216 communicable with the port 214, a power regulator 218 providing power (electricity) to the port 214 and the processing circuitry 216, a power input 220 coupled to the power regulator 218 and configured to receive input power to the controller 144 for provision to the power regulator 218, and a communications interface 221 coupled to the processing circuitry 216.

As shown in FIG. 2, the power input 220 is configured to receive electrical power (electricity) from an electrical power supply 222. In some embodiments, the electrical power supply 222 is electrical circuitry of the rotary cutter 100 and/or a tractor attached to the rotary cutter 100 (e.g., a 12 volt electrical supply conventionally used to power tail lights, turn signals, brake lights, etc. of a trailer such as a rotary cutter). In some embodiments, the electrical power supply 222 is an energy storage device (e.g., battery, battery pack) included as an element of the monitoring system 200. In some embodiments, the electrical power supply 222 is included as an element of the monitoring system 200 and includes an energy harvesting device, for example configured to convert vibrations of the deck 102 and/or solar irradiation into electricity for powering the monitoring system 200. The power input 220 can include a port, plug, etc. configured to conductively couple the controller 144 to the electrical power supply 222.

The power regulator 218 is configured to receive the electrical power from the power input 220 and provide suitable electrical power to the port 214 and the processing circuitry 216. For example, in some embodiments, the power regulator 218 converts 12V input power (e.g., as provided to the power input 220 by the electrical power supply 222) to 5V power used by the processing circuitry 216 and/or the port 214 (and by the gear box circuitry 202 which receives such power from the port 214 via the cable 204). Other voltages, etc. can be used in various embodiments.

The port 214 is configured to receive the cable 204 such that the controller 144 and the gear box circuitry 202 are coupled together and conductively connected by the cable 204. The port 214 is configured to provide electrical power to the gear box circuitry 202 via the cable 204, as received from the power regulator 218, for example for powering the light source(s) 212, the sensor(s) 208, and the sensor driver 210. The port 214 is also configured to receive measurements by the sensor(s) 208 via the cable 204 and provide such measurements to the processing circuitry 216. The port 214 is also configured to receive a control input (control signal, control decision, command, on/off switching, etc.) for the light source(s) and provide the control input to the light source(s) 212 via the cable 204 and the port 206 of the gear box circuitry 202. In some embodiments, the port 214 (and/or the port 206) is configured as a uniform serial bus (USB) port, USB-C port, etc.

The processing circuitry 216 is configured to receive measurements from the one or more sensor(s) and control the light source(s) 212 based on the measurements. The processing circuitry 216 can control the light source(s) 212 to turn on, emit light, blink, flash, change color etc. in response to a measurement by the sensor(s) satisfying a criterion.

In some embodiments, the processing circuitry 216 receives a measurement from the sensor(s), compares the measurement to a threshold value, and causes the light source(s) 212 to turn on (e.g., continuously illuminate, blink, flash) if the measurement exceeds the threshold value (e.g., is greater than the threshold value, is less than a threshold value). For example, the sensor(s) may measure (and the measurement may indicate) a temperature of the gear box and the threshold value may be a threshold temperature value, such that the processing circuitry 216 causes the light sources 212 to turn on in response to a measured temperature of the gear box exceeding the threshold temperature value (i.e., in response to determining that the gear box is hotter than the threshold temperature value). Such an example results in the light source(s) 212 illuminating to communicate a warning, alert, alarm, etc. to an operator of the rotary cutter 100 that a gear box 114/116/118 is at a higher-than-desired temperature, which may be indicative of an oil leak or other fault condition.

In some embodiments, the processing circuitry 216 receives measurements over time and assesses a set of measurements (e.g., from a last minute, last two minutes, last ten minutes, etc.) and determines whether the set of measurements satisfies a criterion. For example, the processing circuitry 216 may determine whether a particular proportion (e.g., half, three-quarters, etc.) of the measurements over a time period exceed a threshold value. In such examples, the processing circuitry 216 can control the light source(s) 212 to illuminate in response to at least the particular proportion of the measurements exceed the threshold value. Such an approach enables the processing circuitry 216 to avoid turning on the light source(s) 212 in response to transient, temporary, outlier, etc. measurements by the sensor(s) 208.

Various other criteria can be assessed (additionally or alternatively) by the processing circuitry 216 based on measurements from the sensor(s) 208 in various embodiments. For example, the processing circuitry 216 may execute trend analysis on measurements such that the processing circuitry 216 can detect upwards (or downwards) trend in a measured condition. As another example, the processing circuitry 216 may assess an average, standard deviation, variance, or other statistical property of the measurements to determine if a criterion is satisfied. Various such criteria, properties, etc. are within the scope of the present disclosure.

In embodiments including multiple gear boxes and multiple units of gear box circuitry 202 (e.g., consistent with FIG. 1), the processing circuitry 216 can control the light source(s) 212 at the multiple gear boxes individually (i.e., separately, independently) or together (e.g., in a coordinated manner). In some embodiments, the processing circuitry 216 controls the light source(s) 212 at multiple gear boxes to blink together, flash in a pattern across the gear boxes, etc., in response to a condition at one of the gear boxes satisfying a criterion (e.g., in response to one gear box exceeding a threshold temperature while the other gear boxes remain below the threshold temperature). In other embodiments, the processing circuitry 216 controls the light source(s) 212 at each gear box individual, such the light source(s) 212 only illuminate on the gear box for which measurements satisfy a criterion (e.g., only for a gear box hotter than a threshold and not for gear boxes that remain cooler than the threshold).

In some embodiments, along with causing the light source(s) 212 to turn on, the processing circuitry 216 is configured to provide related data to the communications interface 221. In some embodiments, such data includes a diagnostic code, fault code, error message, etc. indicating the criterion determined to be satisfied (i.e., the reason that the light source(s) 212 were turned on). In some embodiments, such data includes one or more measurements received by the processing circuitry 216 from the sensor(s) 208.

The communications interface 221 is configured to provide communications between the controller 144 (e.g., the processing circuitry 216) and a user interface device 224, for example such that the user interface device 224 can be used as an indicator (e.g., as an alternative to or in addition to the light source(s) 212) and/or to provide more information about measurements provided by the sensor(s) 208. The communications interface 221 provides wireless communications via a standard communications protocol (e.g., Bluetooth, WiFi, etc.), in some embodiments. In some embodiments, the user interface device 224 is a personal computing device (e.g., smartphone, tablet, laptop computer, augmented or virtual reality headset), which may run a program (e.g., mobile application) associated with the rotary cutter 100. In some embodiments, the user interface device 224 is a display panel of a tractor (or other vehicle, equipment, etc.) used to operate the rotary cutter 100, and, in some such embodiments, the communications interface 221 provides communications (e.g., wired communications) to a controller area network (CAN) bus of the tractor. In some embodiments, the user interface device 224 is adapted to provide haptic feedback to a user (e.g., vibration, etc.). In some embodiments, the user interface device 224 is configured provide audible feedback to a user (e.g., an audio alarm). In some embodiments, the user interface device 224 is a display output (e.g., screen, LED array, etc. included as an element of the monitoring system 200 (e.g., coupled to the controller 144, mounted on the hub) configured to display an error code, fault code, diagnostic message, etc. provided by the processing circuitry 216 via the communications interface 221. The communications interface 221 thereby enables an operator to access information about a condition of a gear box that triggered illumination of the light source(s) 212.

In some embodiments, the communications interface 221 is configured to communication with control circuitry of a tractor or other equipment providing mechanical power to the rotary cutter 100. In some such embodiments, the communications interface 221 in coordination with the processing circuitry 216 is configured to cause the tractor (or other equipment) to stop providing mechanical power to the rotary cutter 100 in response to measurements satisfying one or more criteria (e.g., in coordination with illuminating the light sources 212).

Referring now to FIG. 3, a storyboard-style illustration of operation of a gear box 300 including the gear box circuitry 202, according to some embodiments. The gear box 300 can be one of the first gear box 114, the second gear box 116, and the third gear box 118 as in FIG. 1, for example. The storyboard-style illustration of FIG. 3 includes a first frame 311, a second frame 312, and a third frame 313 showing the gear box 300 at different stages of operation.

As shown in first frame 311, the gear box 300 includes a body 302, an input shaft 304 extending from the body 302, a base 305 extending from the body 302 at approximately a right angle with the input shaft 304, and a cover 306 coupled to the body 302 such that the body 302 extends between the cover 306 and the base 305. The input shaft 304 is configured to be coupled to a source of input rotational power, for example to the first shaft 120 or the second shaft 124 of FIG. 1. The base 305 is configured to couple the gear box 300 to the deck 102 of the rotary cutter 100 and to provide a rotating output extending through the deck 102 and configured to be coupled to a blade of the rotary cutter 100 in order to control rotation of the blade. The gear box 300 includes gears that translate rotation of input shaft 304 to rotation of a output member of the base, wherein such input and output rotations are about different axes, e.g., axes at approximately right angles relative to one another.

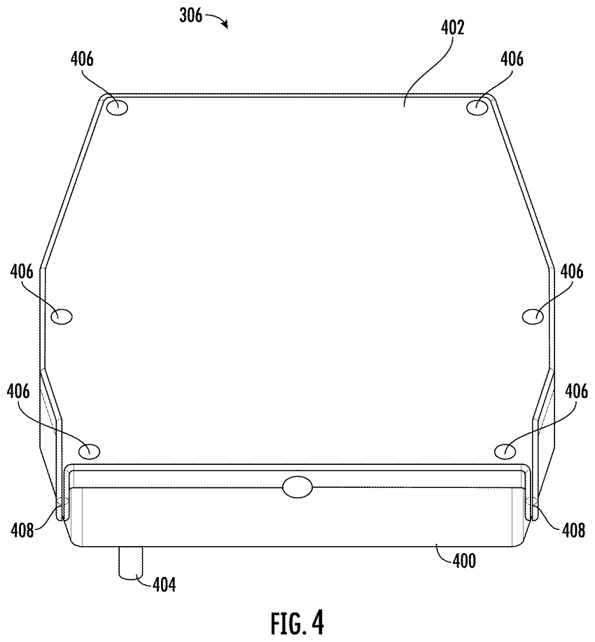

The gear box 300 is also shown as including a light bar 308 coupled to (e.g., mounted on) the cover 306. The cover 306 is shown in detail in FIGS. 4-7 and described in detail below with reference thereto. The light bar includes multiple LEDs arranged in one or more rows along a length of the light bar 308. The light bar is an example embodiment of any of the light source(s) 212, the first light source 134, the second light source 138, and the third light source 142.

In the first frame 311, the light bar 308 is turned off, i.e., the LEDs thereof are not emitting light. The first frame 311 can represent the gear box 300 in an acceptable operating condition, for example where a measurement by a sensor at the gear box 300 indicates that a condition of the gear box 300 is an acceptable range, below a threshold value, etc.

In the second frame 312, the light bar 308 is operating to emit light of a first color (e.g., red). As shown, a first subset of the LEDs of the light bar 308, which are configured to emit light of the first color, are operated in the second frame 312. The second frame 312 may be entered in response to a measurement by a sensor at the gear box 300 satisfying a condition, e.g., exceeding a threshold value, and/or in response to other operations and control output of the processing circuitry 216.

In the third frame 313, the light bar 308 is operating to emit light of a second color (e.g., white). As shown, a second subset of the LEDs of the light bar 308, which are configured to emit light of the second color are operated in the third frame 313. The third frame 313 may be part of a pattern of illumination provided in response to the measurement by a sensor at the gear box 300 satisfying a condition, e.g., exceeding a threshold value, and/or in response to other operations and control output of the processing circuitry 216. For example, the light bar 308 may be controlled such that operation of the light bar 308 repeatedly switches between the second frame 312 and the third frame 313 to provide an illumination pattern easily visible to a user of the rotary cutter 100. When a condition at the gear box is resolved (e.g., a measured value drops back past a threshold value), the processing circuitry 216 can turn off the light bar 308 to return to the first frame 311.

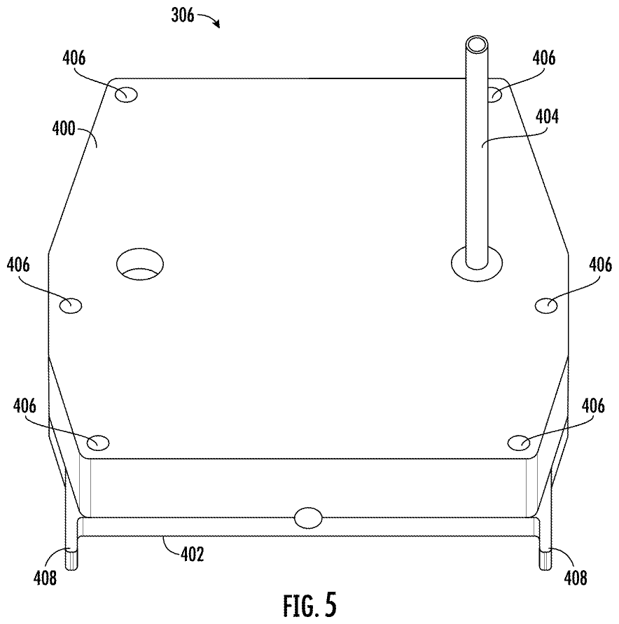

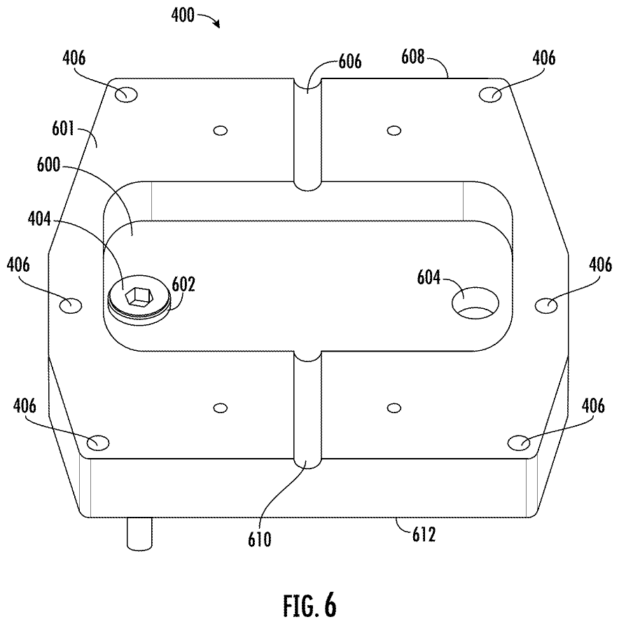

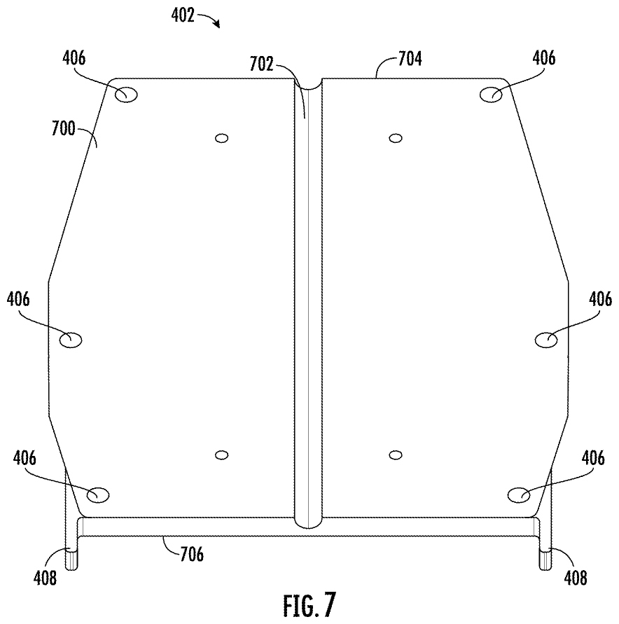

Referring now to FIGS. 4-7, views of the cover 306 of the gear box 300 are shown, according to some embodiments. FIG. 4 shows a perspective, top view of the cover 306, FIG. 5 shows a perspective, bottom view of the cover 306, FIG. 6 shows a perspective, top view of a bottom panel 400 of the cover 306, and FIG. 7 shows a perspective, bottom view of a top panel 402 of the cover 306. FIGS. 4-7 show the cover 306 with a sensor plug 404 installed in the cover 306.

The cover 306 has an octagonal prism shape, with the bottom panel 400 and the top panel 402 having substantially-matching octagonal perimeters. Other shapes may be used in other embodiments, and the cover 306 may be shaped to match a topside of the gear box 300, for example shaped based on design of the gear box 300. The cover 306 can thus act to cover the topside of the gear box 300, for example blocking access to an interior of the gear box 300 which would be accessible in the absence of the cover 306. The cover 306 includes peripheral through-holes 406 extending through both the bottom panel 400 and the top panel 402, through bolts, screws, other fasteners, etc. can be inserted to couple the cover 306 to the gear box 300 and to couple the top panel 402 to the bottom panel 400. The top panel 402 further includes a mounting extensions 408 extending from the top panel 402 beyond the octagonal perimeter thereof, with the mounting extensions 408 configured to hold, couple to, support, etc. the light bar 308 (see FIG. 3).

The bottom panel 400 is configured to be placed adjacent to (e.g., set directly on) the gear box 300. The bottom panel 400 includes a cavity 600 therein, with the cavity 600 positioned on a top side 601 of the bottom panel 400 (i.e., a side facing the top panel 402). The cavity 600 is formed as a reduction in thickness of the bottom panel 400 relative to other portions of the bottom panel 400. The cavity 600 is configured to house (hold, contain, receive, etc.) components of the gear box circuitry 202, for example the port 206 and the sensor driver 210, various wiring, etc.

A first plug hole 602 and a second plug hole 604 are located in the cavity 600 and extend through the bottom panel 400 at the cavity 600. The first plug hole 602 and the second plug hole 604 allow access from the cavity 600 into an interior of the gear box 300. As shown in FIGS. 4-6, the sensor plug 404 is positioned in the first plug hole 602. The sensor plug 404 is thereby partially exposed to an interior of the gear box 300 such that the sensor plug 404 (a sensor thereof as described in further detail below) can measure a condition inside the gear box 300 (e.g., an internal temperature of the gear box 300). The sensor plug 404 further acts to substantially seal the first plug hole 602 such that oil, etc. is restricted from leaving the gear box 300 via the first plug hole 602. The second plug hole 604 is shown as open (unfilled, exposed), but may receive a second sensor plug (e.g., in embodiments including multiple sensors for one gear box) and/or a sensor-less plug configured to restrict oil, etc. from leaving the gear box via the second plug hole 604.

The bottom panel 400 is further shown to include a first channel 606 extending from the cavity 600 to a first end 608 of the bottom panel 400 and a second channel 610 extending from the cavity 600 to a second end 612 of the bottom panel 400. The first end 608 and the second end 612 are opposite ends of the bottom panel 400, such that the first channel 606 and the second channel 610 extend in opposite directions from the cavity 600 in the example shown. The first channel 606 and the second channel 610 are formed as depressions, recesses, etc. in the top side 601 of the bottom panel 400, and provide pathways for cables, wires, etc. to pass into and out of the cavity 600. In particular, the cable 204 (as shown in FIG. 2) or one of the cables 146/148/150 (as shown in FIG. 1) can extend along the first channel 606 and wiring between light source(s) 202 (e.g., light bar 308, light source 134/138/142) and the port 206 and/or other components of gear box circuitry 202 can extend along the second channel 610.

The top panel 402 is configured to abut the bottom panel 400 such that a bottom surface 700 of the top panel 402 abuts the top side 601 of the bottom panel 400 (except at the cavity 600, the first channel, and the second channel 610). The cavity 600 thus provides an open space between the bottom panel 400 and the top panel 402. The top panel 402 includes a third channel 702 which extends across the top panel 402 from first end 704 of the top panel 402 to a second end 706 of the top panel 402. The third channel 702 aligns with the first channel 606 and the second channel 610 of the bottom panel 400 when the cover 306 is assembled, such that the first channel 606 and the second channel 610 combine with the third channel 702 to provide pathways between the bottom panel 400 and the top panel 402 for passage of cable, wire, etc. into and out of the cavity 600. The mounting extensions 408 are included with the top panel 402 and extend from the top panel 402 at the second end 706 of the top panel.

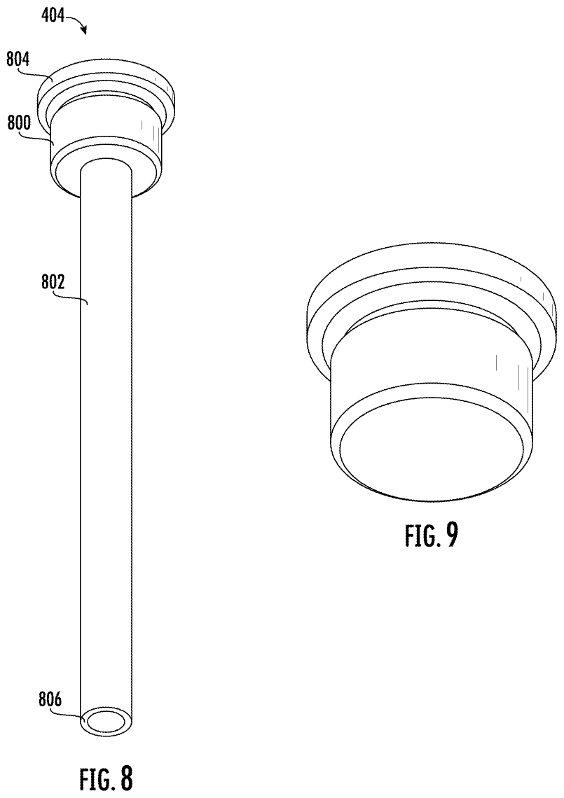

Referring now to FIG. 8, the sensor plug 404 is shown, according to some embodiments. The sensor plug 404 is shown as including a plug body 800, a stick 802 coupled to and extending from the plug body 800, and a cap 804 coupled to the plug body 800 such that the plug body 800 is between the stick 802 and the cap 804. The plug body 800 has a cylindrical shape configured to substantially match (e.g., fill) the first plug hole 602 and/or the second plug hole 604. The cap 804 is coupled to the plug body 800 can facilitate manipulation of the sensor plug 404 (e.g., insertion and/or removal of the plug body 800 from the first plug hole 602 and/or the second plug hole 604) and prevent the sensor plug 404 from falling through the first plug hole 602 and/or the second plug hole 604. In some embodiments, the cap 804 includes conductive outputs (pin(s), wiring, port, etc.) to facilitate electrical connection of the sensor plug 404 to the sensor driver 210 or other elements of gear box circuitry 202.

The stick 802 is arranged to extend into an interior of the gear box 300. In some embodiments, the stick 802 includes a sensor (e.g., thermocouple) installed at distal end 806 of the stick 802, with wiring extending through a body of the stick from the sensor, through the plug body 800 and to and/or out through the cap 804. In other embodiments, the sensor (e.g., thermocouple) is provided in the plug body 800, and the stick 802 is adapted to cause conditions of the gear box 300 to reach the plug body 800 for measurement by the sensor. For example, the stick 802 may be a highly heat-conductive material adapted to quickly track the temperature of the gear box such that measuring a temperature of the stick 802 at the plug body 800 can be accurately characterized as measuring an interior temperature of the gear box. The stick 802 can include various types of sensors or other characteristics to facilitate different types of measurements (measurements of various conditions) in various embodiments. For example, sensors disposed along the stick 802 can be used to measure an oil level in the gear box, in some embodiments.

Referring now to FIG. 9, an view of a plug 900 is shown, according to some embodiments. The plug 900 is an implementation of the sensor plug 404 omitting the stick 802. The plug 900 can contain one or more sensors, in some embodiments. In some embodiments, different plug designs are used for different types of sensors, different conditions to measured, etc., for example as illustrated by the plug 900 and the sensor plug 404.

### Configuration of Exemplary Embodiments

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. A rotary cutter, comprising:
a gear box;
a sensor coupled to the gear box and configured to measure a condition of the gear box;
a light source coupled to the gear box; and
processing circuitry communicatively coupled to the sensor and the light source, wherein the processing circuitry is configured to cause the light source to illuminate in response to determining that a measurement from the sensor satisfies a criterion.

2. The rotary cutter of claim 1, wherein the rotary cutter further comprises a blade coupled to an output of the gear box and a drive member coupled to an input of the gear box, wherein the gear box comprises gears configured to transfer rotation of the drive member to rotation of the blade.

3. The rotary cutter of claim 1, wherein the sensor is disposed inside the gear box.

4. The rotary cutter of claim 1, wherein:
the gear box comprises a cover;
the cover comprises a port;
the rotary cutter comprises a plug positioned in the port; and
the sensor is disposed on the plug such that the sensor is inside the gear box; and
the rotary cutter comprises a wire extending from the sensor, through the plug, and out of the gear box via the port.

5. The rotary cutter of claim 1, wherein:
the processing circuitry is physically spaced apart from the gear box;
the rotary cutter comprises a cable extending from the processing circuitry;
the rotary cutter comprises circuitry positioned at the gear box and configured to provide electrical connection between the cable, the sensor, and the light source.

6. The rotary cutter of claim 1, wherein the sensor is a temperature sensor and the criterion comprises a threshold temperature.

7. The rotary cutter of claim 1, wherein the sensor is an accelerometer and the criterion comprises a threshold vibration frequency or threshold vibration amplitude.

8. The rotary cutter of claim 1, wherein the light source is positioned on the gear box.

9. The rotary cutter of claim 1, further comprising:
an additional gear box; and
an additional light source positioned on the additional gear box;
wherein the processing circuitry is communicatively coupled to the additional light source.

10. The rotary cutter of claim 1, further comprising an additional sensor spaced apart from the gear box, wherein the additional sensor is configured to measure a condition of a portion of the rotary cutter other than the gear box.

11. The rotary cutter of claim 10, wherein the rotary cutter comprises a mower deck and the additional sensor is coupled to the mower deck.

12. A method of operating a rotary cutter, comprising:
measuring, by a sensor disposed in a gear box of the rotary cutter, a condition of the gear box;
determining, by processing circuitry and based on a signal from the sensor, whether the condition satisfies a criterion;
causing, by the processing circuitry, a light source positioned at the gear box to illuminate in response to determining that the condition satisfies the criterion.

13. The method of claim 12, further comprising driving rotation of a blade coupled to an output of the gear box by providing rotational power via a drive member coupled to an input of the gear box and transforming, by gears of the gear box, the rotational power from the drive member into the rotation of the blade.

14. The method of claim 12, comprising transmitting the signal from the sensor to the processing circuitry via a wire extending from the sensor and through a plug positioned in a port of the gear box to the processing circuitry.

15. The method of claim 12, comprising transmitting the signal from the gear box to the processing circuitry with the processing circuitry spaced apart from the gear box.

16. The method of claim 12, wherein the condition is temperature and the criterion is a threshold temperature.

17. The method of claim 12, wherein the condition is vibration frequency or amplitude and the criterion is a threshold vibration frequency or threshold vibration amplitude.

18. The method of claim 12, further comprising measuring, by an additional sensor positioned on a mower deck of the rotary cutter, a condition of the mower deck and providing, from the additional sensor, a signal indicative of the condition of the mower deck to the processing circuitry.

19. A gear box for a rotary cutter comprising:
walls defining an interior volume;
a cover coupled to the walls, the cover comprising a port;
a plug positioned in the port;
a sensor disposed on the plug such that the sensor is positioned in the interior volume; and
a wire extending from the sensor along the plug and out of the interior volume via the port.

20. The gear box of claim 19, further comprising a light source coupled to the cover.
